(19) United States
(12) Patent Application Publication
(10) Pub. No.: US 2023/0135737 A1
(43) Pub. Date: May 4, 2023

(54) MODEL ADJUSTMENT METHOD, MODEL ADJUSTMENT SYSTEM AND NON- TRANSITORY COMPUTER READABLE MEDIUM

(71) Applicant: INSTITUTE FOR INFORMATION INDUSTRY, Taipei City (TW)

(72) Inventors: Shih Yu LU, Taipei City (TW); Sung-min LIAO, Taipei City (TW); Veeresha Ramesha ITTANGIHALA, Taipei City (TW); Shih-Kai LU, Taipei City (TW); Xaver CHEN, Taipei City (TW)

(73) Assignee: INSTITUTE FOR INFORMATION INDUSTRY, Taipei City (TW)

(21) Appl. No.: 17/538,314

(22) Filed: Nov. 30, 2021

(30) Foreign Application Priority Data
Oct. 29, 2021 (TW) 110140257

(51) Int. Cl. G06K 9/62; G06N 20/00; G06F 21/30

(52) U.S. Cl. CPC G06K 9/6253; G06K 9/6201; G06N 20/00; G06F 21/30

(57) ABSTRACT

A model adjustment method, comprises: by a processing device, performing: obtaining inferred data that is inferred using a model, performing a feedback mechanism on the inferred data to obtain a feedback command associated with correctness of the inferred data, adjusting the inferred data according to the feedback command to generate adjusted data, and using the adjusted data as one of a plurality of pieces of training data for retraining the model. The present disclosure further provides a model adjustment system and non-transitory computer readable medium.

### CROSS-REFERENCE TO RELATED APPLICATIONS

This non-provisional application claims priority under 35 U.S.C. § 119(a) on Patent Application No(s). 110140257 filed in Republic of China (ROC) on Oct. 29, 2021, the entire contents of which are hereby incorporated by reference.

### BACKGROUND

### 1. Technical Field

This disclosure relates to a model adjustment method, especially to a model adjustment method for retraining a model.

### 2. Related Art

With the rapid progress of deep learning technology, deep neural network has been gradually and widely used in various fields, such as smart manufacturing. With deep learning technology, machines may determine the abnormality, forecast future trend or perform other analysis based on sensed data generated from equipment (including machines, sensors, etc.)

in the factory.

Signals generated from products with different model numbers (such as motors) may also differ from each other even if they are the same type of products, and these signals thereby may not be applied with the same detection model. Therefore, for a new product, it is often necessary to collect the signals generated by the new product and adjust the detection model accordingly. However, in a large factory, since there is a large amount of measuring equipment corresponding to various products, it would very time-consuming and laborious to collect data and deploy models manually.

### SUMMARY

Accordingly, this disclosure provides a model adjustment method, a model adjustment system and a non-transitory computer readable medium.

According to one or more embodiments of this disclosure, a model adjustment method includes: by a processing device, performing: obtaining inferred data that is inferred using a model; performing a feedback mechanism on the inferred data to obtain a feedback command associated with correctness of the inferred data; adjusting the inferred data according to the feedback command to generate adjusted data; and using the adjusted data as one of pieces of training data for retraining the model.

According to one or more embodiments of this disclosure, a model adjustment system includes: a storage device storing a model; a processing device connected to the storage device, and configured to perform: obtaining inferred data that is inferred using a model; performing a feedback mechanism on the inferred data to obtain a feedback command associated with correctness of the inferred data; adjusting the inferred data according to the feedback command to generate adjusted data; and using the adjusted data as one of pieces of training data for retraining the model.

According to one or more embodiments of this disclosure, a non-transitory computer readable medium includes at least one computer executable program, wherein steps are performed when the at least one computer executable program is executed by a processor, and the steps include: obtaining inferred data that is inferred using a model; performing a feedback mechanism on the inferred data to obtain a feedback command associated with correctness of the inferred data; adjusting the inferred data according to the feedback command to generate adjusted data; and using the adjusted data as one of pieces of training data for retraining the model.

With the above structure, the model adjustment method, model adjustment system and non-transitory computer readable medium disclosed in this disclosure may generate high-quality training data to retrain the model and thereby improving the accuracy of the model by performing the feedback mechanism and data adjustment on the data inferred by the model.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram illustrating a model adjustment system according to an embodiment of the present disclosure;

FIG. 2 is a flowchart illustrating a model adjustment method according to an embodiment of the present disclosure;

FIG. 3 is a schematic diagram illustrating time series data according to an embodiment of the present disclosure;

FIGS. 4A and 4B are schematic diagrams respectively illustrating inferred data and adjusted data that are classified as labeled data according to an embodiment of the present disclosure;

FIG. 5 is a schematic communication diagram of a model adjustment system performing a model adjustment method according to another embodiment of the present disclosure;

FIG. 6 is a functional block diagram illustrating a model adjustment system according to yet another embodiment of the present disclosure; and

FIG. 7 is a schematic communication diagram of a model adjustment system performing a model adjustment method according to yet another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

Please refer to FIG. 1, a functional block diagram illustrating a model adjustment system 1 according to an embodiment of the present disclosure. As shown in FIG. 1, the model adjustment system 1 includes a storage device 11 and a processing device 13 connected to each other. In an implementation, the storage device 11 and the processing device 13 may be respectively disposed at an edge end and a cloud end, and the two devices are connected to each other via the Internet.

The storage device 11 may include, but not limited to, a flash memory, a hard disk drive (HDD), a solid state drive (SSD), a dynamic random access memory (DRAM) or a static random access memory (SRAM). The storage device 11 stores one or more trained models, and the trained models may include one or more of a classification model, a regression model, and a forecasting model. Moreover, the storage device 11 may also store pieces of pipeline data and profiles. In an implementation, the storage device 11 may include a storage and a database, wherein the storage stores the models, the pipeline data and the profiles mentioned above, and the database stores metadata indicating the mapping relationship between the above-mentioned data and their physical storage locations. The processing device 13 may include, but not limited to, one or more processors, such as a central processing unit (CPU), a graphics processing unit (GPU), etc. The processing device 13 is configured to adjust the data inferred by the trained model through a feedback mechanism, and to use the adjusted data as training data to retrain the trained model. The steps performed by the processing device 13 are described below.

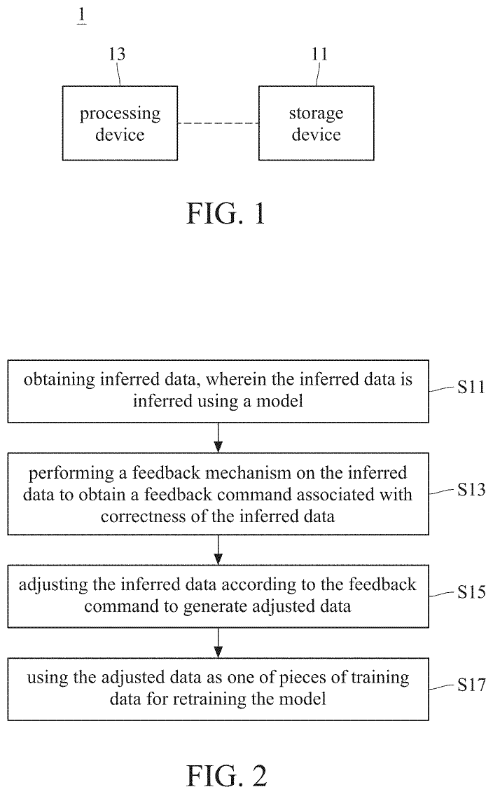

Please refer to FIGS. 1 and 2, wherein FIG. 2 is a flowchart illustrating a model adjustment method according to an embodiment of the present disclosure. As shown in FIG. 2, the model adjustment method may include steps S11, S13, S15 and S17. The model adjustment method shown in FIG. 2 may be performed by the processing device 13 of the model adjustment system 1 shown in FIG. 1, but the present disclosure is not limited thereto. For better understanding, the steps of the model adjustment method are exemplarily described using the operation of the processing device 13 in the following.

In step S11, the processing device 13 obtains the inferred data, wherein the inferred data is generated by performing inference by the trained model stored in the storage device 11. Further, another processing device (hereinafter referred to as “external device”) may input the data generated by equipment and collected by an edge device (hereinafter referred to as “equipment data”) into the trained model, for the trained model to perform inference on the equipment data and to generate the inferred data. Furthermore, the processing device 13 may be a processing device disposed at the cloud end, and the external device may be a processing device disposed at the edge end. The processing device 13 may obtain the inferred data from the external device through Internet. The inferred data may include input data of the model (i.e., the equipment data) and the inference result generated by the model. For example, the inferred data may be time series data or labeled data. For the time series data, the input data may be followed by the inference result on the time axis; for example, the inference result is the prediction result. For the labeled data, the inference result may be implemented by labelling data in the input data that conforms to a specific condition, for example, labeling abnormal values.

In step S13, the processing device 13 performs the feedback mechanism on the inferred data to obtain a feedback command associated with correctness of the inferred data. Moreover, for different types of inferred data, the processing device 13 may perform different feedback mechanisms.

For example, for time series data, the feedback mechanism may include: determining a future time interval corresponding to the inferred data; obtaining real time data generated in the future time interval after the future time interval passes; and comparing the inferred data with the real time data to generate a comparison result; wherein the comparison result is used as the feedback command. As described above, the inferred data classified as time series data may include the equipment data generated in a past time interval and the inference result that is predicted to be obtained in the future time interval. The processing device 13 may store the inferred data, record the corresponding future time interval, and continuously receive other inferred data. After the future time interval (hereinafter referred to as “time interval Ti”) passes, the time interval Ti becomes a past time interval, and the processing device 13 may determine whether the inferred data newly received includes the equipment data generated in the time interval Ti to generate a determined result, wherein the equipment data is the above-mentioned real time data, and may represent the correct data corresponding to the time interval Ti. When the determined result is positive, the processing device 13 obtains the real time data and compares the real time data with the inferred data stored previously to generate a comparison result, wherein the comparison result includes, for example, a numerical difference between the real time data and the inference result. When the determined result is negative, the processing device 13 may wait for the next inferred data and perform the above-mentioned determining step on it.

As another example, for the labeled data, the feedback mechanism may include: outputting the inferred data through a user interface; and obtaining an operation command in response to the inferred data through the user interface; wherein the operation command is used as the feedback command. Specifically, the processing device 13 may show the inferred data to a user through a screen of a computer or other personal devices, and the user may revise the inference result (i.e. generate the above-mentioned operation command) through a computer or other personal devices to correct the wrong part of the inference result. That is, the operation command may indicate the correct data.

In particular, the processing device 13 may include processing modules running different feedback mechanisms, and the external device may be informed whether the data to be processed is classified as time series data or labeled data (for example, being informed by pipeline data) when performing inference on the data to be processed using the trained model. Therefore, the external device may transmit the inferred data to the processing module having a suitable feedback mechanism.

In step S15, the processing device 13 adjusts the inferred data according to the feedback command to generate adjusted data. Specifically, the feedback command generated from the feedback mechanism applicable to the time series data may include the numerical difference between the correct data and the inference result, and the processing device 13 may adjust the inference result in the inferred data to be similar or identical to the correct data according to said numerical difference; the feedback command generated from the feedback mechanism applicable to the labeled data may include the command for revising the inference result, and the processing device 13 may adjust the inferred data according to the command. The data adjusted through the above method is the adjusted data.

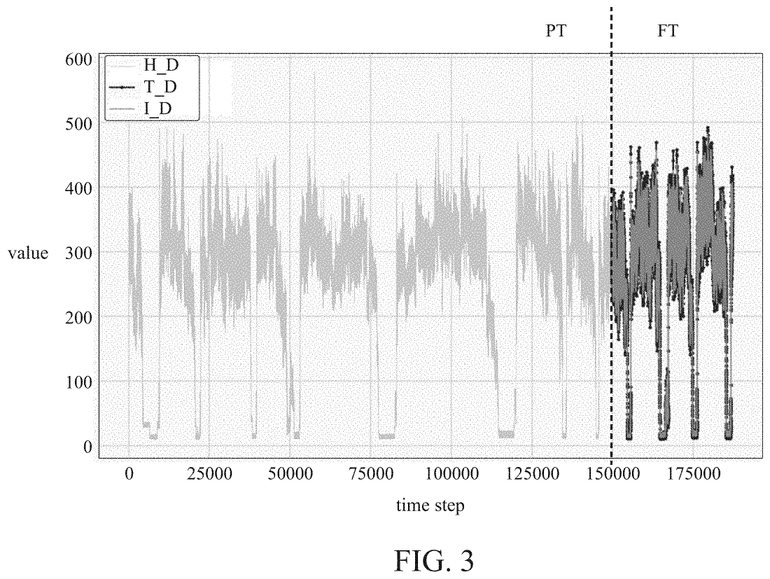

Please refer to FIG. 3, a schematic diagram illustrating time series data according to an embodiment of the present disclosure. FIG. 3 exemplarily shows historical data H_D, the inference result I_D and real data T_D. The historical data H_D is the equipment data generated in the past time interval PT. The inference result I_D is the predicted result corresponding to the future time interval FT, and is obtained by inputting the equipment data into the model. The real data T_D is the equipment data actually generated in the future time interval FT. The inferred data may include the historical data H_D and the inference result I_D, and the processing device may store the inferred data and record the future time interval FT after receiving the inferred data. After the future time interval FT passes, the processing device may obtain the real data T_D, compare the inference result I_D with the real data T_D, adjust the inference result I_D in the inferred data to be identical or similar to the real data T_D, and then use the adjusted inferred data as the training data.

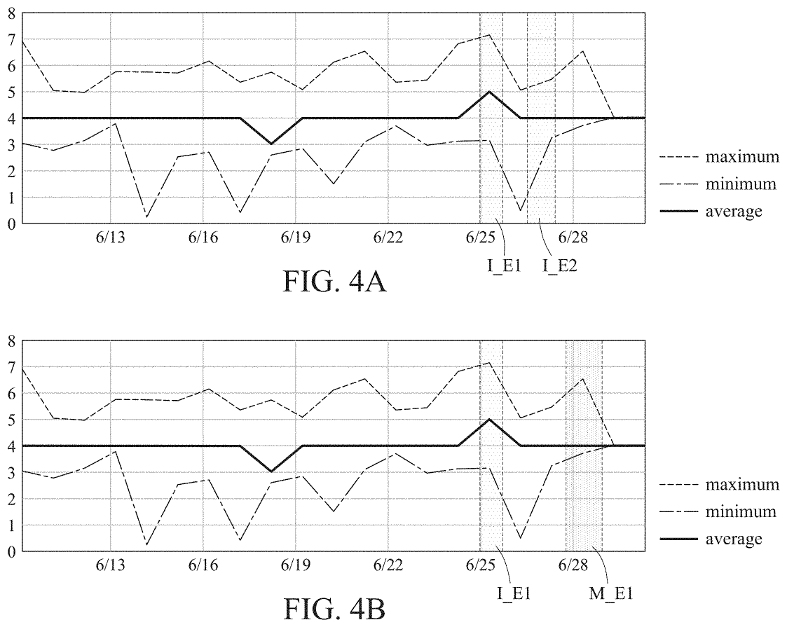

Please refer to FIGS. 4A and 4B, which are schematic diagrams respectively illustrating inferred data and adjusted data that are classified as labeled data according to an embodiment of the present disclosure. FIGS. 4A and 4B exemplarily present the user interface. As shown in FIG. 4A, the labeled-type inferred data includes equipment data shown by three types of lines (maximum, minimum and average of sensed values) and inference labels I_E1 and I_E2, which indicate the parts of the equipment data conforming to the specific conditions (e.g., the numerical relationships between the three pieces of equipment data are abnormal) determined by the model. The user may revise the data shown in FIG. 4A; for example, the user may delete the label that is false positive or/and add a new label to a false negative part. As shown in FIG. 4B, the user may delete the inference label I_E2 that is false positive, and add a manual label M_E1 to the false negative part. The processing device may adjust the inferred data according to the operation command provided by the user as described above, and then use the adjusted inferred data as the training data. In particular, FIG. 4B may be regarded as a schematic diagram of the adjusted data.

Please refer to FIGS. 1 and 2 again. In step S17, the processing device 13 uses the adjusted data as one of pieces of training data to retrain the model. Specifically, the processing device 13 may perform the steps S11 to S15 repeatedly to obtain pieces of adjusted data, then use these pieces of adjusted data to retrain the model. The processing device 13 may store the retrained model into the storage device 11 as an updated version of the model. The data of the stored model may include, but not limited to, a blueprint configuration file for module deployment. Moreover, the processing device 13 may notify the external device about the updated model so as to drive the external device to obtain the updated model from the storage device 11 and use the updated model to perform inference on equipment data received subsequently to generate corresponding inferred data. The processing device 13 may then perform the feedback mechanism and data adjustment as mentioned above on the data inferred by the retrained model to generate training data for new round of training.

The processing device 13 may retrain the model for multiple rounds. As the number of said rounds increases, the accuracy of the model also increases. In particular, for the model corresponding to the labeled data, as the number of rounds of retraining increases, the parts of the inferred data need to be labeled manually (for example, deleting false positive label and adding false negative label as mentioned above) decreases. Table 1 exemplarily shows experimental data of the model of the labeled data.

TABLE 1

| | Percentage of | Percentage of | |
|---|---|---|---|
| | manual labeling | machine labeling | Accuracy |
| First round | 90% | 10% | 81.1% |
| Second round | 50% | 50% | 86.6% |
| Third round | 10% | 90% | 97% |

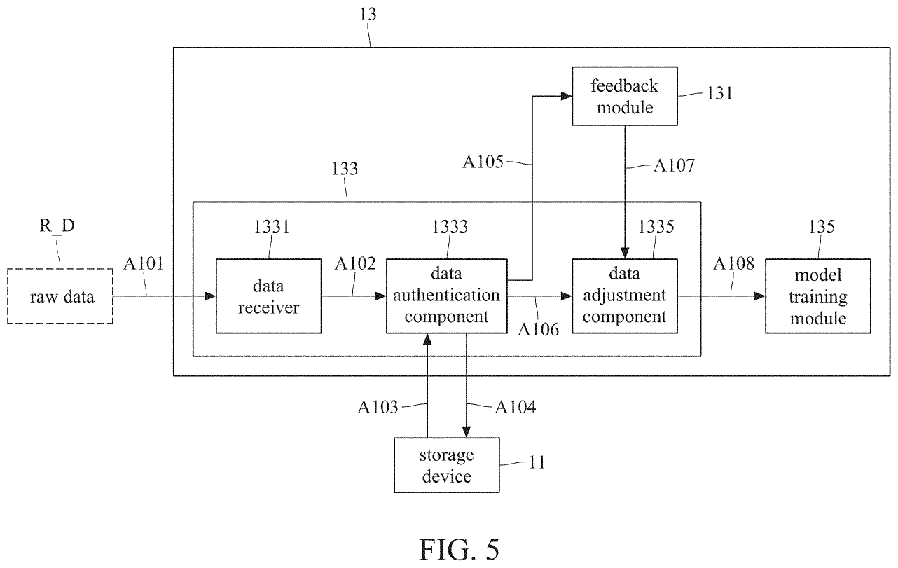

In another embodiment, aside from performing the feedback mechanism, data adjustment and model retraining as described above, the model adjustment system may further perform a data authentication mechanism before performing said steps. Please refer to FIG. 5, a schematic communication diagram of a model adjustment system performing a model adjustment method according to another embodiment of the present disclosure.

As shown in FIG. 5, the processing device 13 may include a feedback module 131, a data version control module 133 and a model training module 135, wherein the data version control module 133 may include a data receiver 1331, a data authentication component 1333 and a data adjustment component 1335. The feedback module 131, the data adjustment component 1335 and the model training module 135 may respectively perform the feedback mechanism, the data adjustment and the model retraining as described in the aforementioned embodiments (i.e., steps S13, S15 and S17 of FIG. 2). The data authentication component 1333 is configured to perform the authentication mechanism, its details are described below. The data receiver 1331 is configured to receive unauthorized inferred data (hereinafter referred to as “raw data R_D”) from the external device. The above-mentioned modules and components in the modules may be formed by serverless computing code, may each be regarded as a function, and may each be implemented by a virtual container or a pod/a container in Kubernetes (K8S).

In communication operations A101 and A102, the data receiver 1331 of the data version control module 133 receives and transmits the raw data R_D to the data authentication component 1333. The data authentication component 1333 performs the authentication mechanism on the raw data R_D, wherein the authentication mechanism includes determining whether the raw data R_D matches the model (will be referred to as “target model”) corresponding to the data version control module 133. As described above, the external device may learn whether the raw data R_D is time series data or labeled data when generating the raw data R_D, and transmit the data accordingly. However, unexpected event may happen during data transmission, thereby causing the data to be transmitted to the wrong processing module (for example, the data version control module 133). With the authentication mechanism, the data authentication component 1333 may eliminate the raw data R_D with above-mentioned conditions.

The data authentication component 1333 reads a profile corresponding to the target model from the storage device 11 through communication operation A103 to confirm whether the raw data R_D matches the target model, wherein the profile includes information such as data format, data characteristics required by the target model. If the raw data R_D matches the target model, the data authentication component 1333 stores the raw data R_D into the storage device 11 (communication operation A104), and transmits the raw data R_D to the feedback module 131 and the data adjustment component 1335 (communication operations A105 and A106). If the raw data R_D does not match the target model, the data authentication component 1333 abandons the raw data R_D, and after the data receiver 1331 receives another piece of raw data, the data authentication component 1333 performs the authentication mechanism described above on said another piece of raw data. Then, the feedback module 131 performs the feedback mechanism described in the above embodiments, and transmits the feedback command to the data adjustment component 1335 (communication operation A107). The data adjustment component 1335 performs the data adjustment described in the above embodiments and transmits the adjusted data to the model training module 135 (communication operation A108), and the model training module 135 uses the adjusted data as the training data for retraining the model.

The model training module 135 may automatically perform model training according to one of AutoML profiles, wherein AutoML profiles are categorized into classification, regression and forecasting. The model training includes two stages which are initial model adjustment stage and subsequent model adjustment stage. During the initial model adjustment stage, the model training module 135 performs hyperparameter tuning and algorithm auto-selection on the default model training code. After finding an optimum solution for the first time, the model training module 135 starts using the adjusted data as the training data to retrain the model, and this is the subsequent model adjustment stage, wherein the adjusted data is the data generated from adjusting the inferred data as described above. As the number of rounds of retraining increases, the accuracy of the model increases.

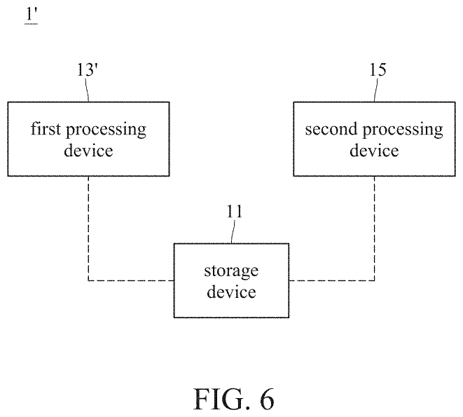

Please refer to FIG. 6, a functional block diagram illustrating a model adjustment system according to yet another embodiment of the present disclosure. In this embodiment, the model adjustment system 1′ includes the storage device 11, a first processing device 13′ and a second processing device 15, wherein the storage device 11 is connected to the first processing device 13′ and the second processing device 15. In an implementation, the storage device 11 and the second processing device 15 are disposed at the edge end, and the first processing device 13′ is disposed at the cloud end. The operations of the storage device 11 and the first processing device 13′ are identical or similar to the operation of the storage device 11 and the processing device 13 as described in the above embodiments, and are omitted herein.

The second processing device 15 may include, but not limited to, one or more processors, such as a central processing unit (CPU), a graphics processing unit (GPU), etc. The operation of the second processing device 15 is identical or similar to the operation of the external device as described in the above embodiments. That is, the second processing device 15 may obtain the equipment data, use the model to perform inference on the equipment data to generate the inferred data, and transmit the inferred data to the first processing device 13′. Moreover, the second processing device 15 may obtain the model retrained by the first processing device 13′ from the storage device 11 based on the notification from the first processing device 13′, and use the retrained model to perform inference on the equipment data received subsequently.

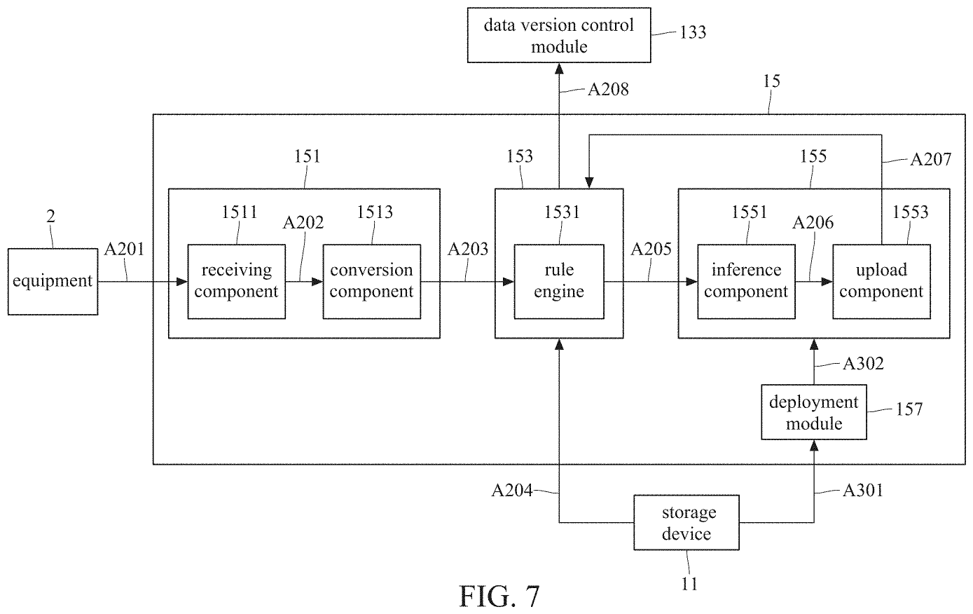

The following further describes the modules and components that may perform the operation of the above-mentioned second processing device 15. Please refer to FIG. 7, a schematic communication diagram of a model adjustment system performing a model adjustment method according to yet another embodiment of the present disclosure. As shown in FIG. 7, the second processing device 15 may include an equipment data module 151, a decision module 153, an inference module 155 and a deployment module 157, wherein the equipment data module 151 may include a receiving component 1511 and a conversion component 1513, the decision module 153 may include a rule engine 1531, and the inference module 155 may include an inference component 1551 and an upload component 1553. Said modules and components in the modules may be formed by serverless computing code, may each be regarded as a function, and may each be implemented by virtual container or a pod/a container in Kubernetes.

In communication operation A201, the receiving component 1511 of the equipment data module 151 receives the equipment data from equipment 2. The receiving component 1511 may support one or more communication protocols, such as representational state transfer (REST), OPC-UA, Modbus, building automation and control network (BACnet), ZigBee, Bluetooth low energy (BLE), message queuing telemetry transport (MQTT), simple network management protocol (SNMP), etc. The receiving component 1511 may receive data from one or more types of equipment. The equipment 2 may be a machine, a sensor, etc. disposed at the edge end, and may generate various measuring data or sensed data (collectively referred to as the equipment data), and transmit the equipment data to the equipment data module 151. The equipment data module 151 may periodically ask the equipment 2 for the equipment data, or the equipment 2 may periodically and actively transmit the equipment data to the equipment data module 151, which is not limited in the present disclosure.

In communication operation A202, the receiving component 1511 transmits the equipment data to the conversion component 1513. The conversion component 1513 may convert the equipment data into the data in the format required by the decision module 153, which includes parameters, information and historical data, etc. The conversion component 1513 may determine the topic carried by the data, and then transmit the data to a rule engine 1531 of the decision module 153 through MQTT (communication operation A203). The rule engine 1531 may perform different operations based on the topic of the received data, which includes inference operation, data uploading operation and model updating operation. Specifically, the corresponding relationships between topics and the operations may be preset in the rule engine 1531. The control component in the decision module 153 may read the corresponding profile and pipeline data from the storage device 11 according to the operation determined by the rule engine 1531 (communication operation A204), for the rule engine 1531 to perform subsequent operation.

For example, when the rule engine 1531 determines the received data has a topic corresponding to the inference operation, the rule engine 1531 may transmit the data to the inference module 155 to drive this module to operate; when the topic corresponds to the uploading operation, the rule engine 1531 may transmit the data to the data version control module 133 to drive this module to operate; the topic corresponds to the model updating operation, the rule engine 1531 may transmit the data to the deployment module 157 to drive this module to operate.

FIG. 7 shows the embodiment where the topic received by the rule engine 1531 through communication operation A203 corresponds to the inference operation. In communication operation A205, the rule engine 1531 transmits the data to the inference component 1551 of the inference module 155. The inference component 1551 inputs the data into the model to generate the inferred data, and transmits the inferred data to the upload component 1553 (communication operation A206). The upload component 1553 labels the inferred data with a topic corresponding to the data uploading operation, and transmits the labeled data to the decision module 153 (communication operation A207). The rule engine 1531 of the decision module 153 determines the inferred data has the topic corresponding to the data uploading operation, and thereby transmits the inferred data to the data version control module 133. Then, the data version control module 133 and other modules in the first processing device 13′ perform the feedback mechanism and data adjustment on the inferred data to generate training data, thereby retraining the model as described in the above embodiments, and the details are omitted herein.

After finishing retraining the model, the first processing device 13′ may, store the retrained model into the storage device 11, and transmit a message containing the topic of the model updating operation to the decision module 153. The rule engine 1531 of the decision module 153 drives the deployment module 157 to update the model based on the topic in the message. In communication operations A301 and A302, the deployment module 157 obtains the blueprint configuration file for module deployment of the retrained model from the storage device 11, and deploys the components in the inference module 155 accordingly. The inference module 155 may then perform the subsequent inference operation using the updated configuration.

In some embodiments, the model adjustment method described in the above embodiments may be included in a non-transitory computer readable medium in a form of at least one computer executable program. For example, the non-transitory computer readable medium may be an optical disk, a USB, a memory card, a hard disk of a cloud server or other computer readable non-transitory storage medium. When the at least one computer executable program is executed by a processor of a computer, the model adjustment method described in the above embodiments is performed.

In some embodiments, the model adjustment method, model adjustment system and non-transitory computer readable medium described in the above embodiments may be applied to artificial intelligence service, such as motor examination, acoustic examination, energy usage, etc.

With the above structure, the model adjustment method, model adjustment system and non-transitory computer readable medium disclosed in the present disclosure may generate high-quality training data to retrain the model and thereby improving the accuracy of the model by performing the feedback mechanism and data adjustment on the data inferred by the model. In comparison with manually-deployed model, the model adjustment method, model adjustment system and non-transitory computer readable medium disclosed in the present disclosure may have a model building process with automatic training, deployment, inference and retraining. These functions of machine learning and active notification may reduce labor costs. In comparison with supervised machine learning, the model adjustment method, model adjustment system and non-transitory computer readable medium disclosed in the present disclosure may reduce the amount of manual work for labeling all data.

What is claimed is:

1. A model adjustment method, comprising: by a processing device, performing:
obtaining inferred data that is inferred using a model;
performing a feedback mechanism on the inferred data to obtain a feedback command associated with correctness of the inferred data;
adjusting the inferred data according to the feedback command to generate adjusted data; and
using the adjusted data as one of a plurality of pieces of training data for retraining the model.

2. The model adjustment method according to claim 1, wherein the feedback mechanism comprises:
determining a future time interval corresponding to the inferred data;
obtaining real time data generated in the future time interval after the future time interval passes; and
comparing the inferred data with the real time data to generate a comparison result;
wherein the comparison result is used as the feedback command.

3. The model adjustment method according to claim 1, wherein the feedback mechanism comprises:
outputting the inferred data through a user interface; and
obtaining an operation command in response to the inferred data through the user interface;
wherein the operation command is used as the feedback command.

4. The model adjustment method according to claim 1, further comprising, by the processing device, performing:
receiving a piece of raw data;
performing an authentication mechanism on the piece of raw data, wherein the authentication mechanism comprises determining whether the piece of raw data matches the model;
if the piece of raw data matches the model, using the piece of raw data as the inferred data; and
if the piece of raw data not matching with the model, after receiving another piece of raw data, performing the authentication mechanism on the another piece of raw data.

5. The model adjustment method according to claim 1, wherein the processing device is a first processing device, and the model adjustment method further comprising: by a second processing device, performing:
obtaining equipment data;
generating the inferred data by performing inference on the equipment data using the model; and
transmitting the inferred data to the first processing device.

6. A model adjustment system, comprising:
a storage device storing a model;
a processing device connected to the storage device, and configured to perform:
obtaining inferred data that is inferred using a model;
performing a feedback mechanism on the inferred data to obtain a feedback command associated with correctness of the inferred data;
adjusting the inferred data according to the feedback command to generate adjusted data; and
using the adjusted data as one of a plurality of pieces of training data for retraining the model.

7. The model adjustment system according to claim 6, wherein the feedback mechanism comprises:
determining a future time interval corresponding to the inferred data;
obtaining real time data generated in the future time interval after the future time interval passes; and
comparing the inferred data with the real time data to generate a comparison result;
wherein the comparison result is used as the feedback command.

8. The model adjustment system according to claim 6, wherein the feedback mechanism comprises:
outputting the inferred data through a user interface; and
obtaining an operation command in response to the inferred data through the user interface;
wherein the operation command is used as the feedback command.

9. The model adjustment system according to claim 6, wherein the processing device is further configured to perform:
receiving a piece of raw data;
performing an authentication mechanism on the piece of raw data, wherein the authentication mechanism comprises determining whether the piece of raw data matches the model;
if the piece of raw data matches the model, using the piece of raw data as the inferred data; and
if the piece of raw data not matching with the model, after receiving another piece of raw data, performing the authentication mechanism on the another piece of raw data.

10. The model adjustment system according to claim 6, wherein the processing device is a first processing device, and the model adjustment system further comprises:
a second processing device connecting the storage device and the first processing device, and configured to obtain equipment data, generate the inferred data by performing inference on the equipment data using the model; and transmitting the inferred data to the first processing device.

11. A non-transitory computer readable medium comprising at least one computer executable program, wherein a plurality of steps are performed when the at least one computer executable program is executed by a processor, and the steps comprise:
obtaining inferred data that is inferred using a model;
performing a feedback mechanism on the inferred data to obtain a feedback command associated with correctness of the inferred data;
adjusting the inferred data according to the feedback command to generate adjusted data; and
using the adjusted data as one of a plurality of pieces of training data for retraining the model.
